(19) United States
(12) Patent Application Publication
(10) Pub. No.: US 2015/0088476 A1
(43) Pub. Date: Mar. 26, 2015

(54) Integrated Model-Based Safety Analysis

(71) Applicants: Zhensheng Guo, Erlangen (DE); Kai Höfig, Munchen (DE)

(72) Inventors: Zhensheng Guo, Erlangen (DE); Kai Höfig, Munchen (DE)

(21) Appl. No.: 14/066,403

(22) Filed: Oct. 29, 2013

(30) Foreign Application Priority Data
Sep. 26, 2013 (EP) 13186054

(51) Int. Cl. G06F 17/50

(52) U.S. Cl. CPC G06F 17/5009
USPC 703/6

(57) ABSTRACT

A method for integrated model-based safety analysis includes integrating a safety analysis model into a system development model of a safety-critical system. The system development model includes model components. The safety analysis model models a failure logic separately for each of the model components. The method includes representing dependencies among the model components with a design structure matrix. The design structure matrix represents each of the model components with a row and a column and shows dependencies between model components with corresponding entries. The method also includes sequencing the design structure matrix, and identifying at least one dependency loop and loop components in the sequenced design structure matrix. The loop components are part of the at least one dependency loop.

This application claims the benefit of EP13186054, filed on Sep. 26, 2013, which is hereby incorporated by reference in its entirety.

### BACKGROUND

Modern safety critical embedded systems tend to increase complexity. To handle this complexity, model-based approaches are introduced in industrial applications and even covered within standards (e.g., ISO26262 for the automotive domain or DO178C for airborne systems). A popular trend for a safety analysis of such systems is to combine safety analysis models and system development models. These widely accepted safety engineering approaches shift the task of failure logic modeling to the layer of model-driven development. These safety engineering approaches integrate or at least relate safety analysis models to elements of functional system development models. This is beneficial for the consistency and also the traceability between safety engineering and system development models.

Approaches that rely on port interconnections mislead to transfer loops from the development model to the safety analysis model. Dominik Domis and Mario Trapp, in “Integrating Safety Analyses and Component-Based Design,” in SAFECOMP, pp. 58-71, 2008, teach breaking up such loops automatically for Boolean structures. However, this leads to confusing and hard to read safety analysis models.

Fault tree analysis is one of the major applications for Boolean models in safety analysis. Loops in such models lead to events that are caused by the loops. For analysis, the loops are to be removed from the model in order to solve this illogical dependency. Approaches that generate fault trees deal with the problem of loops and how to prevent the loops (e.g., in “Automatic Reliability Analysis of Electronic Designs Using Fault Trees,” by Peter Liggesmeyer and Oliver Mackel, in Workshop Testmethoden und Zuverlässigkeit von Schaltungen und Systemen, 13, 2000, fault trees are generated from electric design plans, and a hierarchical abstraction approach is used to prevent the generation of loops).

Also, in “Automatic translation of digraph to fault-tree models,” by D. L. Iverson, in Reliability and Maintainability Symposium, Annual Proceedings, pp. 354-362, 1992, fault tree structures are generated. Digraph models are converted, and valid loop free fault trees are generated.

In “Retrenchment, and generation of fault trees for static, dynamic and cyclic systems,” by R. Banach and M. Bozzano, in Proceedings of 25th International Conference, SAFECOMP, pp. 127-141, 2006, fault tree structures are generated for large systems that may also contain loops.

In “A behaviour-based method for fault tree generation,” by Andrew Rae and Peter Lindsay, in Proceedings of the 22nd International System Safety Conference, pp. 289-298, 2004, fault trees are generated over different hierarchy levels and with various cycles in the system development model. Automatically generated fault trees require precise information about failures and propagation of the failures or are only able to generate fault trees for specific applications.

Other approaches deal with the problem of automatically removing existing loops in fault trees. In “How to avoid the generation of loops in the construction of fault trees,” by I. Ciarambino, Politecnico di Torino, S. Contini, M. Demichela, and N. Piccinini, in Reliability and Maintainability Symposium, Annual Proceedings, pp. 178-185, 2002, syntax rules are used to identify and remove loops.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, integrated model-based safety analysis improves a safety analysis model integrated into a system development model of a safety-critical system.

One embodiment of a method for integrated model-based safety analysis includes integrating a safety analysis model into a system development model of a safety-critical system. The system development model includes model components, and the safety analysis model models a failure logic separately for each model component. The method includes representing dependencies among the model components with a design structure matrix. The design structure matrix represents each model component with a row and a column and shows dependencies between model components with corresponding entries. The method also includes sequencing the design structure matrix, and identifying at least one dependency loop and loop components in the sequenced design structure matrix. The loop components are part of the at least one dependency loop.

In one embodiment, a system for integrated model-based safety analysis includes a digital data storage medium that stores a safety analysis model integrated into a system development model of a safety-critical system. The system development model includes model components, and the safety analysis model models a failure logic separately for each model component. The system also includes a microprocessor programmed (e.g., configured) to represent dependencies among the model components with a design structure matrix. The design structure matrix represents each model component with a row and a column and shows dependencies between model components with corresponding entries. The microprocessor is programmed to sequence the design structure matrix, and to identify at least one dependency loop and loop components in the sequenced design structure matrix. The loop components are part of the at least one dependency loop.

In one embodiment, a computer program is stored in a non-transitory computer-readable storage medium and has instructions for integrated model-based safety analysis when executed by one or more processors (e.g., microprocessors). The instructions include integrating a safety analysis model into a system development model of a safety-critical system. The system development model includes model components, and the safety analysis model models a failure logic separately for each model component. The instructions include representing dependencies among the model components with a design structure matrix. The design structure matrix represents each model component with a row and a column and shows dependencies between model components with corresponding entries. The instructions include sequencing the design structure matrix, and identifying at least one dependency loop and loop components in the sequenced design structure matrix. The loop components are part of the at least one dependency loop.

In accordance with an embodiment of the method, the method also includes restructuring the system development model by encapsulating the loop components in a single component in the system development model.

In accordance with another embodiment of the method, the safety analysis model is a Boolean safety analysis model.

In accordance with a further embodiment of the method, the Boolean safety analysis model includes component fault trees

A popular trend to handle safety analysis of complex software intensive embedded systems is integrated model-based safety analysis. Well accepted safety engineering approaches like fault trees are shifted to the level of model-driven development by integrating safety models into functional development models. This provides benefits for consistency and traceability. The selection of appropriate model elements or level of hierarchies for such an integration is a new task to be tackled. For fault tree-based approaches, the existence of loops in development models may be problematic since loops may not be part of a Boolean model.

To prevent such loops in safety analysis models, the method uses design structure matrices (DSMs) to cluster architecture elements with loops or with strong coupling. The method re-clusters components of system development models into structures that do not contain loops. Design structure matrices (DSMs) are used to minimize the changes and to identify such loops. Using this method, small adjustments in the architecture model provide improvements when modeling a seamless integrated safety analysis model.

In “Integrating Safety Analyses and Component-Based Design,” by Dominik Domis and Mario Trapp, in SAFECOMP, pp. 58-71, 2008, Boolean structures are analyzed, and loops are removed from the safety analysis model. This approach, however, requires prior recognition by the analyst of the initiation of a loop. By preventing loops during the design phase, the method enables automations for fault tree structures that do not require interactions with analysts. The method prevents the modeling of loops by restructuring elements of system development models.

The method restructures system development models in order to prevent loops in fault trees using design structure matrices (DSMs). Even if restructuring the system development model is impossible, the DSM approach may help to identify clusters of components where loops may be expected. This may help to improve the process of modeling fault trees and gives hints where development teams for different components need frequent balancing.

### BRIEF DESCRIPTION OF THE DRAWINGS

FIG. 1 illustrates two views of an example system with interacting blocks and corresponding component integrated fault trees (CFTs);

FIG. 2 illustrates a design structure matrix DSM for the example system from FIG. 1 (left matrix) and a sequenced design structure matrix DSM' after the sequencing algorithm (right matrix); and

FIG. 3 illustrates an example system after applying the sequencing algorithm with interacting blocks and corresponding CFTs.

### DETAILED DESCRIPTION

Examples are illustrated in the accompanying drawings. Like reference numerals refer to like elements throughout.

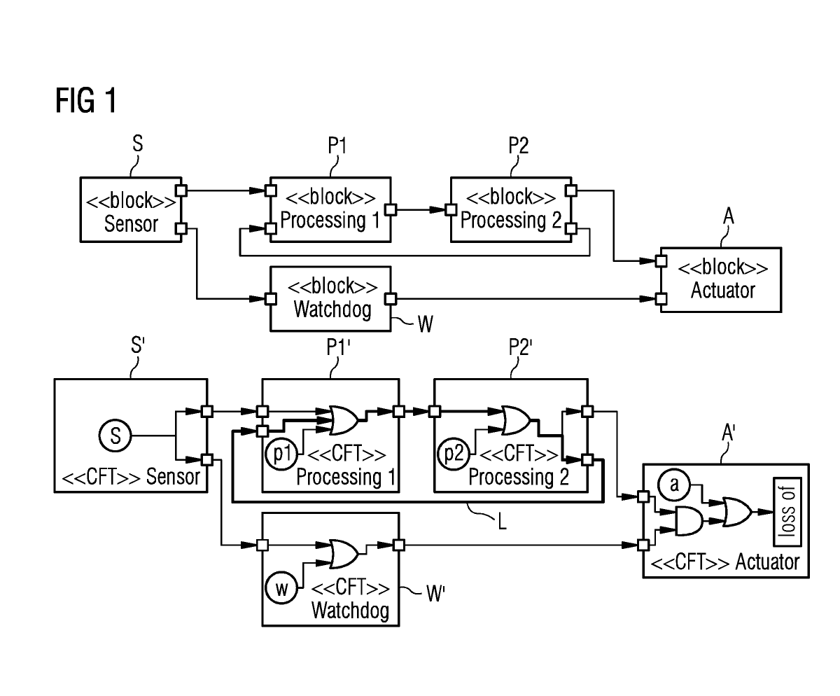

Boolean safety analysis models that are highly integrated into architecture models of a safety-critical system lead to model loops. FIG. 1 shows a SysML internal block diagram (IBD) of a small open-loop example system and the corresponding Boolean safety analysis model. The model elements marked as blocks represent the components of the system. A sensor S evaluates a sensor value and provides the signal to a first processing component P1. A second processing component P2 interacts with the first processing component P1 until a result is calculated that is forwarded to an actuator A. A watchdog W monitors the time the processing components P1, P2 require for calculating a command. If a time line is exceeded, the watchdog W sets the actuator A in a safe state.

In the lower part of FIG. 1, component fault trees (CFTs) are used as a safety analysis model using Boolean logic, as described in “A new component concept for fault trees,” by Bernhard Kaiser, Peter Liggesmeyer, and Oliver Mackel, in Safety Critical Systems and Software 2003, Eighth Australian Workshop on Safety-Related Programmable Systems, Canberra, ACT, Australia, 9-10 Oct. 2003, Volume 33 of CRPIT, pages 37-46, Australian Computer Society, 2003.

CFTs are an extension to classic fault trees. CFTs are integrated into the model of a safety-critical system in order to model the failure logic separately for each component. A failure propagates from one component to another following the ports and the connections between the ports. For example, the watchdog W′ gets a signal from the sensor S′ and provides a signal to the actuator A′. The command provided to the actuator A′ is either erroneous if the input is erroneous or if the watchdog W′ contains an internal error (e.g., basic event w and OR-gate within the watchdog CFT).

If such Boolean structures are part of safety-critical systems, the architecture models may contain loops. Such loops are prohibited in Boolean models. An example for a loop L within the architecture model is shown in FIG. 1 for the first processing component P1′ and the second processing component P2′. The loop L is marked by the thick black line. If these components are developed by different teams, such a Boolean loop L may be introduced into the model. The example system is comparatively small and only contains a single failure mode. For larger structures and many people involved in a development process, such loops may be of various complexities.

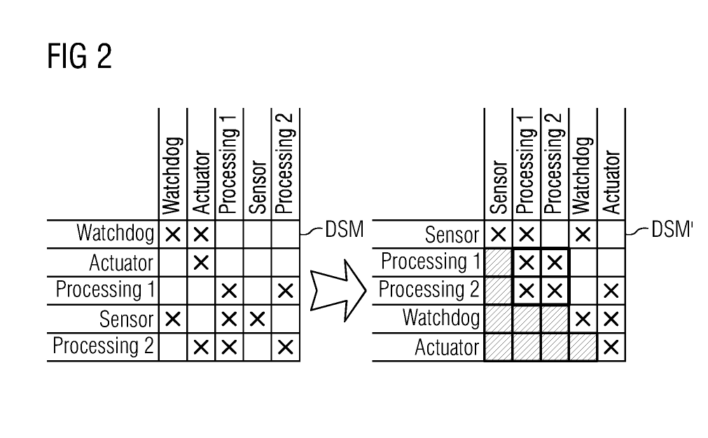

A design structure matrix represents dependencies among various items that may be processes, products, components or organizations. The design structure matrix DSM for the example system illustrated in FIG. 1 is shown in FIG. 2 on the left side. Each component has a row and a column in the design structure matrix DSM. All components depend on themselves, and so, the diagonal of the design structure matrix DSM is crossed. The rows show provisions (e.g., the row Sensor shows that the sensor component sends signals to the components Watchdog and Processing 1). The columns of the design structure matrix DSM show dependencies (e.g., the column Actuator shows that the actuator component receives signals from the Watchdog component and the Processing 2 component).

Using these relations within the design structure matrix DSM, the matrix may be sequenced to identify dependency loops. The corresponding algorithm is described by John N. Warfield, in “Binary matrices in system modeling,” Systems, Man and Cybernetics, IEEE Transactions on SMC 3 (5), pp. 441-449, September 1973. The result of this algorithm is shown in FIG. 2 on the right side. All dependencies are in the right upper part of the matrix DSM′. In the left lower part (grey area) is only one dependency between Processing 1 and Processing 2. Without this cross mark, the matrix DSM′ would be upper triangular, which provides that there are no loops in the development model. So, if the components Processing 1 and Processing 2 are encapsulated within one component, the dependencies between the components of the example system are free of loops, and modeling loops in component fault trees is prevented.

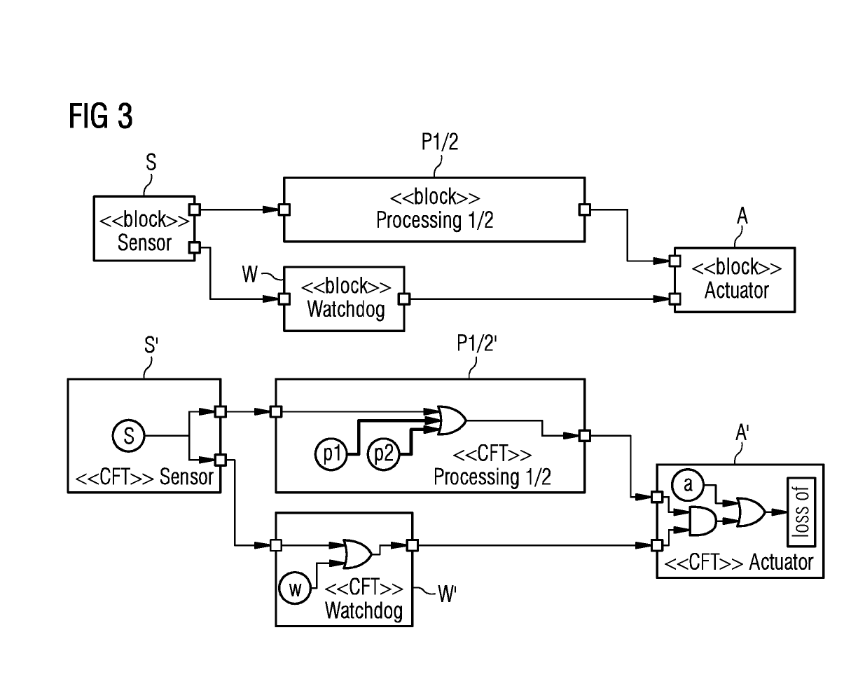

FIG. 3 shows the system with the encapsulation of the first processing component P1 and the second processing component P2 into one processing component P1/2. As shown in the CFT model for this encapsulated architecture, all connections between the ports of the model are straightforward and do not form loops. So, loops are not erroneously modeled in the safety analysis model even if the components and corresponding component fault trees are modeled by different teams. The design structure matrix may help to identify such loops in the architecture and to identify the corresponding components to be encapsulated for safety analysis.

The invention has been described in detail with reference to embodiments thereof and examples. Variations and modifications may, however, be effected within the spirit and scope of the invention covered by the claims. The phrase “at least one of A, B and C” as an alternative expression may provide that one or more of A, B and C may be used.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for integrated model-based safety analysis, the method comprising:
integrating a safety analysis model into a system development model of a safety-critical system, the system development model comprising model components, and the safety analysis model modeling a failure logic separately for each of the model components;
representing dependencies among the model components with a design structure matrix, the design structure matrix representing each of the model components with a row and a column and showing dependencies between the model components with corresponding entries;
sequencing the design structure matrix; and
identifying at least one dependency loop and loop components in the sequenced design structure matrix, the loop components being part of the at least one dependency loop.

2. The method of claim 1, further comprising restructuring the system development model, the restructuring comprising encapsulating the loop components into a single component in the system development model.

3. The method of claim 1, wherein the safety analysis model is a Boolean safety analysis model.

4. The method of claim 2, wherein the safety analysis model is a Boolean safety analysis model.

5. The method of claim 3, wherein the Boolean safety analysis model comprises component fault trees.

6. The method of claim 4, wherein the Boolean safety analysis model comprises component fault trees.

7. A system for integrated model-based safety analysis, the system comprising:
a digital data storage medium configured to store a safety analysis model that is integrated into a system development model of a safety-critical system, the system development model comprising model components and the safety analysis model modeling a failure logic separately for each of the model components; and
a microprocessor configured to:
represent dependencies among the model components with a design structure matrix, the design structure matrix representing each of the model components with a row and a column and showing dependencies between the model components with corresponding entries;
sequence the design structure matrix; and
identify at least one dependency loop and loop components in the sequenced design structure matrix, the loop components being part of the at least one dependency loop.

8. The system of claim 7, wherein the microprocessor is further configured to restructure the system development model, such that the loop components are encapsulated into a single component in the system development model.

9. The system of claim 7, wherein the safety analysis model is a Boolean safety analysis model.

10. The system of claim 9, wherein the Boolean safety analysis model comprises component fault trees.

11. A non-transitory computer-readable storage medium storing a computer program having instructions executable by a processor for integrated model-based safety analysis, the instructions comprising:
integrating a safety analysis model into a system development model of a safety-critical system, the system development model comprising model components and the safety analysis model modeling a failure logic separately for each of the model components;
representing dependencies among the model components with a design structure matrix, the design structure matrix representing each of the model component with a row and a column and showing dependencies between the model components with corresponding entries;
sequencing the design structure matrix; and
identifying at least one dependency loop and loop components in the sequenced design structure matrix, the loop components being part of the at least one dependency loop.

12. The non-transitory computer-readable storage medium of claim 11, wherein the instructions further comprise restructuring the system development model, the restructuring comprising encapsulating the loop components into a single component in the system development model.

13. The non-transitory computer-readable storage medium of claim 1, wherein the safety analysis model is a Boolean safety analysis model.

14. The non-transitory computer-readable storage medium of claim 13, wherein the Boolean safety analysis model comprises component fault trees.
